(19) United States
(12) Patent Application Publication
(10) Pub. No.: US 2009/0174470 A1
(43) Pub. Date: Jul. 9, 2009

(54) LATCH-UP PROTECTION DEVICE

(75) Inventor: Jen-Chou Tseng, Hsinchu (TW)

Correspondence Address: J C PATENTS, INC., 4 VENTURE, SUITE 250, IRVINE, CA, 92618, US

(73) Assignee: WINBOND ELECTRONICS CORP., Hsinchu (TW)

(21) Appl. No.: 11/971,385

(22) Filed: Jan. 9, 2008

(51) Int. Cl. G05F 1/10

(52) U.S. Cl. 327/546

(57) ABSTRACT

A latch-up protection device is provided. The latch-up protection device includes a first transistor, a detection module, and a processing module. The first transistor includes a first source/drain coupled to a pad, a body and a second source/drain coupled to a first voltage, and a gate. The detection module is adapted for detecting a terminal voltage between the first source/drain and the second source/drain of the first transistor, and generating a first signal when the terminal voltage is greater than a trigger voltage. The processing module is coupled between the detection module and the gate of the first transistor, for conducting a logic processing to the first signal, and generating an enable signal to the gate of the first transistor to conduct the first transistor.

### BACKGROUND OF THE INVENTION

1. Field of the Invention

The present invention generally relates to latch-up protection device, and more particularly, to a latch-up protection device for avoiding a latch-up effect by conducting a current along an additional path.

2. Description of Related Art

Currently, complementary metal oxide silicon (COMS) technology plays a more and more important role in the integrated circuit industry. However, the parasitic circuit effect, which is also known as the latch-up effect, is often a main factor causing self-inflicted damages of IC chips. As such, processing technologies or layout technologies which are adapted for latch-up protection are then demanded for latch-up protection.

For illustration convenience, a CMOS inverter is taken as an example. FIG. 1A is a schematic diagram of an inverter. Referring to FIG. 1A, the inverter 100 includes a P-type transistor M1 and an N-type transistor M2. The P-type transistor M1 has a gate receiving an input signal Vin, a first source/drain coupled to a system voltage VDD, and a second source/drain generating an output signal Vout. The N-type transistor M2 has a gate receiving the input signal Vin, a first source/drain coupled to the second source/drain of the first P-type transistor M1, and a second source/drain coupled to a ground voltage VSS.

FIG. 1B illustrates a cross-sectional view of a layout of the inverter 100 in FIG. 1A. Referring to FIG. 1B, there are shown P+ diffusion regions 111, 112, and a poly-silicon 113 configured in an N-well, serving as the first source/drain, the second source/drain and the gate of the P-type transistor M1 respectively. In a P-substrate, there are configured N+ diffusion regions 121, 122 and a poly-silicon 123, respectively serving as the first source/drain, the second source/drain and the gate of the N-type transistor. In order to prevent body effect, a body of the P-type transistor M1 is usually coupled to the system voltage VDD, as indicated by the N+ diffusion region 114, and a body of the N-type transistor M2 is usually coupled to the ground voltage GND, as indicated by the P+ diffusion region 124.

It can be learnt from FIG. 1B, excepting for the expected P-type transistor M1 and N-type transistor M2, the inverter 100 further includes a parasitic circuit 130 composed of a PNP transistor M3, an NPN transistor M4, and the resistors R_nw and R_sub. The parasitic circuit 130 is also called a silicon-controlled rectifier (SCR).

FIG. 1C illustrates a schematic diagram of the parasitic circuit 130 in FIG. 1B. Referring to FIGS. 1B and 1C, when there is a current flowing through a collector of the PNP transistor M3, which raises a voltage between a base and an emitter of the NPN transistor M4 to about 0.7 V, the NPN transistor M4 will be conducted. Because of the amplification effect of a co-emitting current of the NPN transistor M4, there is a large current generated at the collector of the NPN transistor M4 flowing through the resistor R_nw, so as to enhance the voltage between the emitter and the base of the PNP transistor M3. Meanwhile, when the voltage between the emitter and the base of the PNP transistor M3 is about 0.7 V, the PNP transistor M3 is also conducted, and the conducting current flows through the resistor R_sub. In such a way, a voltage at the base of the NPN transistor M4 is enhanced, which causes a condition of positive feedback called latch-up effect.

In general, transient currents or voltages existing in the circuit, i.e., when an initializing power or external voltage exceeds a normal operation range, often cause latch-ups. In order to eliminate the latch-ups during normal operation of the circuits, epitaxial wafer and retrograde well are typical processing methods employed for reducing substrate resistances and well resistances. In the layout method, it is also desirable to dispose more substrate contacts, e.g., the P+ diffusion region 124, and more well contacts, e.g., the N+ diffusion region 114, so as to reduce substrate resistances and well resistances, or introduce a guard ring to reduce a gain P of the parasitic transistor. Unfortunately, this increases the area of the layout in general.

### SUMMARY OF THE INVENTION

Accordingly, the present invention is directed to a latch-up protection device, which is adapted for avoiding latch-ups so as to protect a circuit for normal operation.

The present invention provides a latch-up protection device including a first transistor, a detection module, and a processing module. The first transistor includes a first source/drain coupled to a pad, a body and a second source/drain coupled to a first voltage, and a gate. The detection module is adapted for detecting a terminal voltage between the first source/drain and the second source/drain of the first transistor, and generating a first signal when the terminal voltage is greater than a trigger voltage. The processing module is coupled between the detection module and the gate of the first transistor, for conducting a logic processing to the first signal, and generating an enable signal to the gate of the first transistor to conduct the first transistor.

The present invention further provides a latch-up protection device. The latch-up protection device includes a first transistor, a second transistor, a first detection module, a second detection module, a first processing module, and a second processing module. The first transistor includes a source/drain coupled to a pad, a body, and a second source/drain coupled to a first voltage, and a gate. The second transistor includes a first source/drain coupled to the first source/drain of the first transistor, a body and a second source/drain coupled to a second voltage, and a gate. The first detection module is adapted for detecting a first terminal voltage between the first source/drain and the second source/drain of the first transistor, and generating a first signal when the first terminal voltage is greater than a trigger voltage. The second detection module is adapted for detecting a second terminal voltage between the first source/drain and the second source/drain of the second transistor, and generating a second signal when the second terminal voltage is greater than the trigger voltage. The first processing module is coupled between the first detection module and the gate of the first transistor, for conducting a logic processing to the first signal and generating a first enable signal to the gate of the first transistor to conduct the first transistor. The second processing module is coupled between the second detection module and the gate of the second transistor, for conducting a logic processing to the second signal and generating a second enable signal to the gate of the second transistor to conduct the second transistor.

The present invention instantly conduct the transistor when the terminal voltage between the first source/drain and the second source/drain of the transistor is detected greater than the trigger voltage, in which an additional path is configured for conducting the current so as to avoid excessive current flowing into the parasitic circuit and causing latch-up thereby.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of an inverter.

FIG. 1B illustrates a cross-sectional view of a layout of the inverter 100 in FIG. 1A.

FIG. 1C illustrates a schematic diagram of the parasitic circuit 130 in FIG. 1B.

FIG. 2A illustrates a latch-up protection device according to an embodiment of the present invention.

FIG. 2B is a circuit diagram of a detection module according to the embodiment of the present invention shown in FIG. 2A.

FIG. 2C is a schematic diagram of a processing module according to the embodiment of the present invention shown in FIG. 2A.

FIG. 3A illustrates a latch-up protection device according to an embodiment of the present invention.

FIG. 3B is a circuit diagram of a detection module according to the embodiment of the present invention shown in FIG. 3A.

FIG. 3C is a schematic diagram of a processing module according to the embodiment of the present invention shown in FIG. 3A.

FIG. 4 illustrates a latch-up protection device according to an embodiment of the present invention.

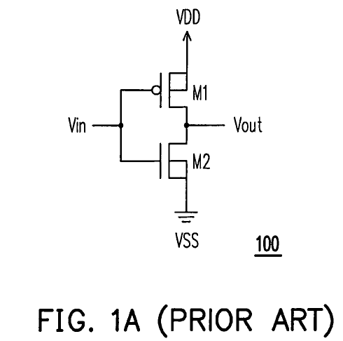

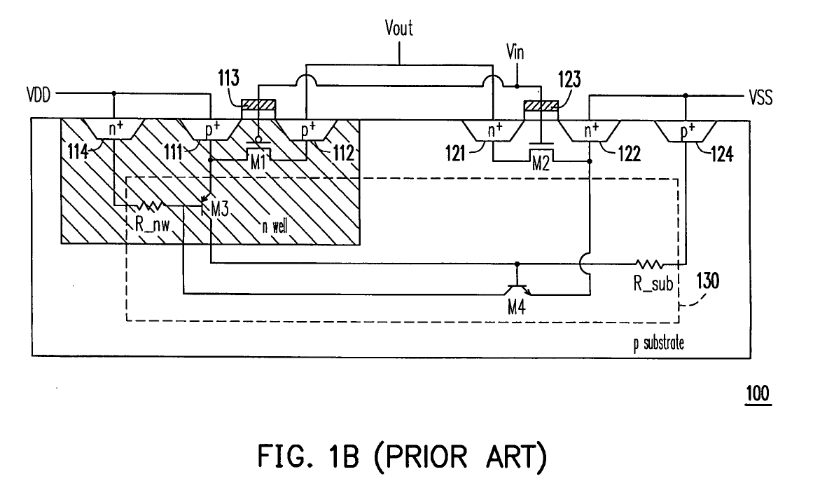

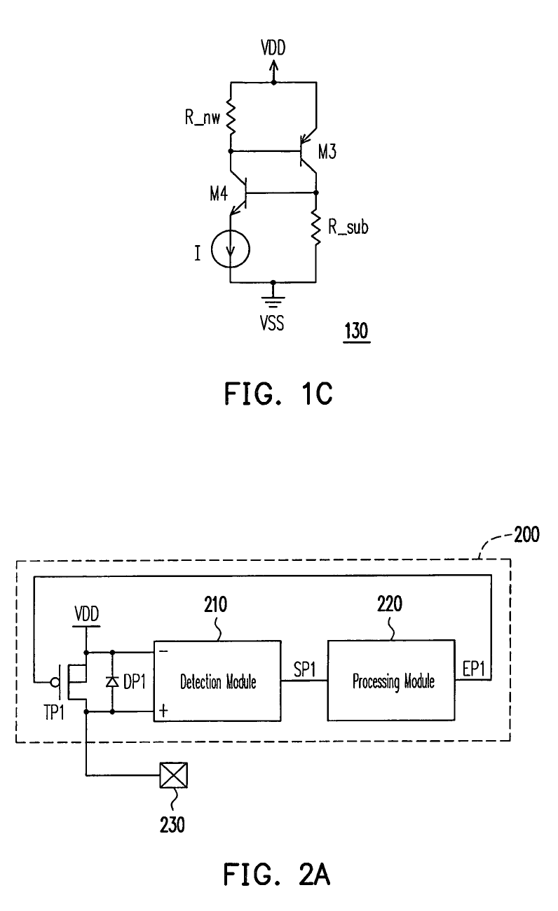

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

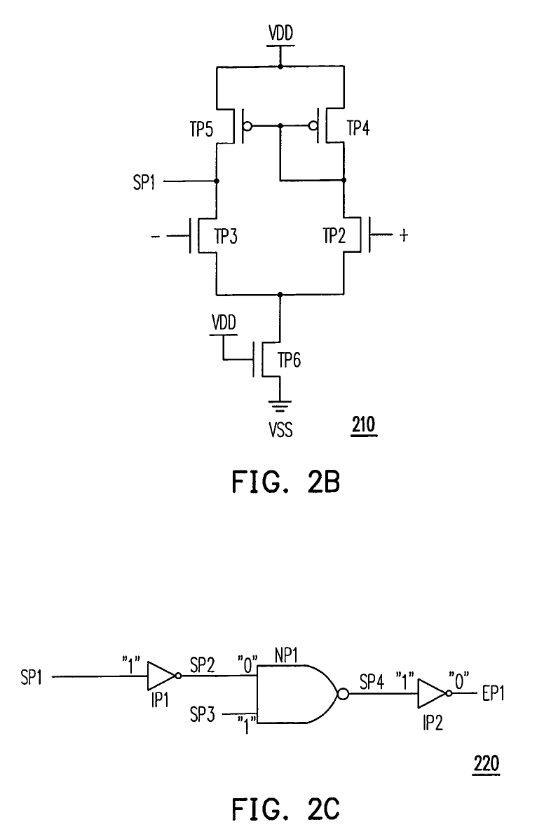

FIG. 2A illustrates a latch-up protection device according to an embodiment of the present invention. Referring to FIG. 2A, there is shown a latch-up protection device 200. The latch-up protection device 200 includes a transistor TP1, a detection module 210, and a processing module 220. The transistor TP1 is a P-type transistor. The transistor TP1 includes a first source/drain coupled to a pad 230 which can be an input pad or an output pad, a body and a second source/drain coupled to a first voltage, i.e., a system voltage VDD according to an aspect of the embodiment, and a gate. The detection module 210 detects a terminal voltage between the first source/drain and the second source/drain of the transistor TP1. When the terminal voltage is greater than a trigger voltage Vd, the detection module 210 generates a signal SP1. The processing module 220 is coupled between the detection module 210 and the gate of the transistor TP1, and is adapted for conducting a logic processing to the signal SP1 and generating an enable signal EP1 to the gate of the transistor TP1 so as to conduct the transistor TP1.

Two different media, or a single medium with an interface formed by two different doping ratio can be considered as a diode during the processing and layout process, and therefore there often exists a parasitic diode DP1 parasitizing in the transistor TP1. The parasitic diode DP1 has an anode terminal and a cathode terminal respectively served by the first source/drain and the second source/drain of the transistor TP1.

When external noises are conducted to the first voltage via the pad 230, the parasitic diode DP1 is conducted with a conduction current. When the conduction current flows to a circuit of a parasitic silicon controlled rectifier (SCR), it often causes an undesired latch-up. As such, according to an embodiment of the present invention, the terminal voltage between the first source/drain and the second source/drain of the transistor TP1 is being detected by the detection module 210. When the terminal voltage is detected to be greater than the trigger voltage Vd so that the parasitic diode DP1 is forward biased, e.g., 0.7 V, the detection module 210 generates the signal SP1. The processing module 220 then conducts a logic processing to the signal SP1, and thus generating an enable signal EP1, and transmitting the enable signal EP1 to the gate of the transistor TP1 to conduct the transistor TP1. In such a way, the conducted transistor TP1 is capable of instantly conducting current, so as to prevent excessive current flowing to the parasitic circuit and causing the undesirable latch-up.

FIG. 2B is a circuit diagram of the detection module 210 according to the embodiment the present invention shown in FIG. 2A. Referring to FIG. 2B, the detection module 210 includes transistors TP2 through TP6 each having a first source/drain, a second source/drain and a gate, in which the transistors TP2, TP3, and TP6 are N-type transistors, and the transistors TP4 and TP5 are P-type transistors. The gate, the first source/drain, and the second source/drain of the transistor TP2 are respectively coupled to the first source/drain of the transistor TP1, the first source/drain of the transistor TP6, and the first source/drain of the transistor TP4. The gate and the first source/drain of the transistor TP3 are respectively coupled to the second source/drain of the transistor TP1 and the first source/drain of the transistor TP2. The second source/drain of the transistor TP3 generates the signal SP1.

The gate and the second source/drain of the transistor TP4 are respectively coupled to the second source/drain of the transistor TP2 and the first voltage, i.e., the system voltage VDD. The gate, the first source/drain and the second source/drain of the transistor TP5 are respectively coupled to the gate of the transistor TP4, the second source/drain of the transistor TP3 and the first voltage. The gate and the second source/drain of the transistor TP6 are respectively coupled to the first voltage and the second voltage, i.e., the ground voltage VSS.

According to an aspect of the embodiment, the detection module 210 is a CMOS differential amplifier composed of a differential pair formed by the transistors TP2 and TP3 and a current mirror formed by the transistors TP4 and TP5. When a voltage difference between the gates of respectively the transistors TP2 and TP3, i.e., the terminal voltage between the first source/drain and the second source/drain of the transistor TP1, is greater than the trigger voltage Vd, the second source/drain of the transistor TP3 generates a logic high level signal SP1. The processing module 220 conducts a logic processing to the signal SP1, so as to generate the enable signal EP1 to conduct the transistor TP1.

FIG. 2C is a schematic diagram of the processing module 220 according to the embodiment of the present invention shown in FIG. 2A. Referring to FIG. 2C, the processing module 220 includes inverters IP1 through IP2, and an NAND gate NP1. As discussed above about the embodiment of FIG. 2B, when the terminal voltage between the first source/drain and the second source/drain of the transistor TP1 is greater than the trigger voltage Vd, the detection module 210 generates a logic high level (“1”) signal SP1. For convenience of illustration, logic level of each signal has been marked in FIG. 2C. As the signal SP1 passes the inverter IP1, a logic low level (“0”) signal SP2 is generated. The signal SP2 and a signal SP3 having a first voltage level, which is for example a logic high level (“1”) of the system voltage VDD, pass the NAND gate NP1 to generate a logic high level signal SP4. The signal SP4 then passes the inverter IP2 to generate a logic low level signal, that is, the enable signal EP1 for conducting the transistor TP1.

It should be noted that although the transistor TP1 is exemplified in this embodiment with a P-type transistor, it can be complied with other components, such as an N-type transistor.

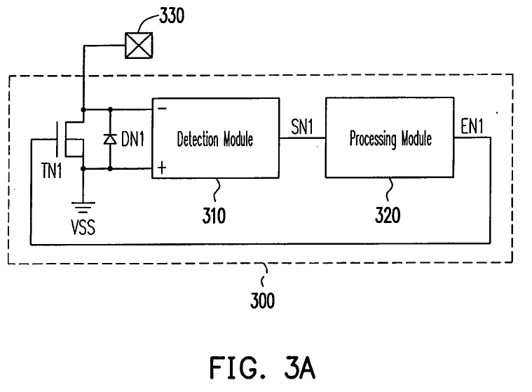

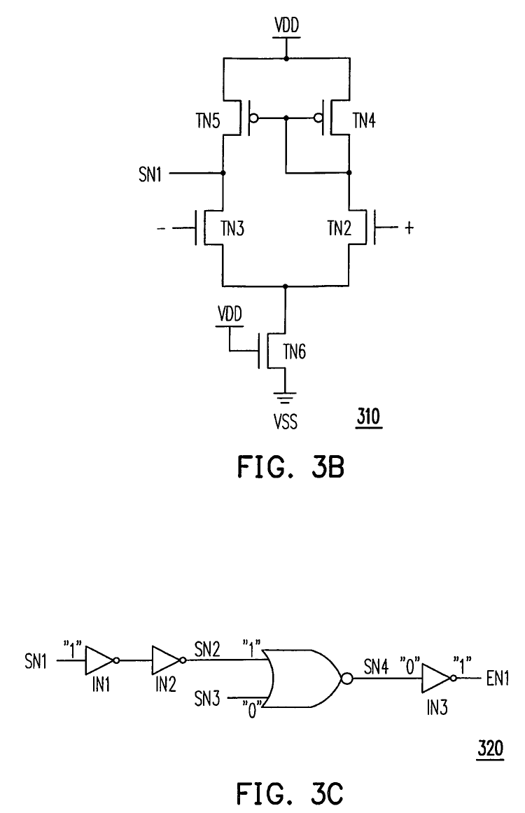

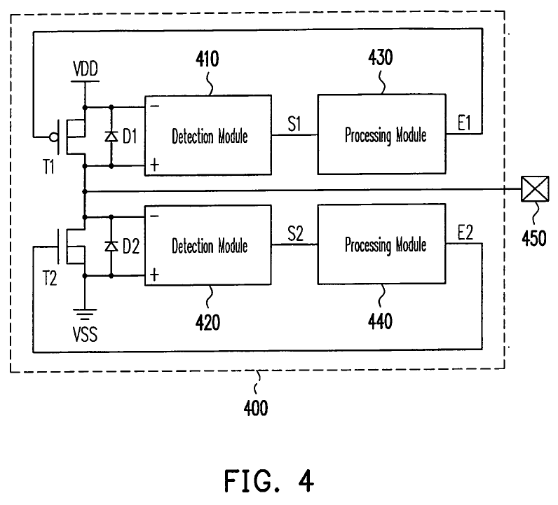

FIG. 3A illustrates a latch-up protection device according to an embodiment of the present invention. Comparing FIG. 3A with FIG. 2A and referring these two drawings together, it can be found that FIG. 3A differs from FIG. 2A in that a transistor TN1 is employed in place of the transistor TP1, which the transistor is N-type transistor. Correspondingly, the transistor TN1 includes a first source/drain coupled to a pad 330, a body and a second source/drain coupled to a second voltage, i.e., a ground voltage VSS hereby. There is also parasitic diode DN1 configured between the first source/drain and the second source/drain of the transistor TN1, in which an anode terminal and a cathode terminal of the parasitic diode DN1 are respectively served by the second source/drain and the first source/drain of the transistor TN1.

The operation of the current embodiment is similar to those discussed with reference to FIG. 2A. When a detection module 310 detects that a terminal voltage between the first source/rain and the second source/drain of the transistor TN1 is greater than a trigger voltage Vd and the parasitic diode DN1 is forward biased, it generates a signal SN1. The processing module 320 then conducts a logic processing to the signal SN1, and then generates an enable signal EN1. The enable signal EN1 is then sent to the gate of the transistor TN1 to conduct the transistor TN1 for instantly conducting current.

The detection module 310 can be further learnt by referring to the discussion about the embodiment of FIG. 2B. FIG. 3B is a circuit diagram of a detection module 310 according to the embodiment of the present invention shown in FIG. 3A. Referring to FIGS. 3A and 3B, because the anode terminal and the cathode terminal of the parasitic diode DN1 are respectively served by the second source/drain and the first source/drain of the transistor TN1, according to an aspect of the embodiment, gates of transistors TN2 and TN3 are respectively coupled to the second source/drain and the first source/drain of the transistor TN1, for detecting the terminal voltage between the first source/drain and the second source/drain of the transistor TN1, and determining whether the terminal voltage is greater than the trigger voltage Vd. Similar to the operation described with reference to FIG. 2B, when the terminal voltage between the first source/drain and the second source/rain is greater than the trigger voltage Vd, the detection module 310 generates a logic high level signal SN1. The processing module 320 then conducts a logic processing to the signal SN1 so as to generate the enable signal EN1 to conduct the transistor TN1.

FIG. 3C is a schematic diagram of the processing module 320 according to the embodiment of the present invention shown in FIG. 3A. Referring to FIG. 3C, the processing module 320 includes inverters IN1 through IN3, an NOR gate OR1. For convenience of illustration, logic level of each signal has been marked in FIG. 3C. As the signal SN1 passes the serially connected inverters IN1˜IN2, a logic high level (“1”) signal SN2 is generated. The signal SN2 and a signal SN3 having a second voltage level, which is for example a logic low level (“0”) of the ground voltage VSS, pass the NOR gate OR1, to generate a logic low level signal SN4. The signal SN4 then passes the inverter IN3, to generate a logic high level signal, that is, the enable signal EN1 for conducting the transistor TN1.

To illustrate in a manner understandable to those of ordinary skill in the art, the present invention provides another example latch-up protection device. FIG. 4 illustrates a latch-up protection device 400 according to another embodiment of the present invention. The latch-up protection device 400 includes transistor T1 through T2, detection modules 410 and 420, and processing module 430 and 440. The transistor T1 is a P-type transistor, and the transistor T2 is an N-type transistor. The transistor T1 includes a first source/drain coupled to a pad 450, such as an input pad or an output pad, a body and a second source/drain coupled to a first voltage, i.e., the system voltage VDD. The transistor T2 includes a first source/drain coupled to the first source/drain of the transistor T1, a body and a second source/drain coupled to a second voltage, i.e., a ground voltage VSS.

Because a parasitic diode D1 is configured between the first source/drain and the second source/rain of the transistor T1, when an external noise is transmitted via the pad 450 to the first voltage, the parasitic diode D1 is conducted. The conducting current then flows to the circuit of the parasitic silicon controlled rectifier (SCR), and often causes an undesired latch-up. As such, when the detection module 410 detects that the terminal voltage between the first source/drain and the second source/drain of the transistor T1 is greater than the trigger voltage Vd, a signal S1 is generated. Similarly, the detection module S2 is assigned to detect a terminal voltage between a first source/drain and a second source/drain of the transistor T2, and when this terminal voltage is greater than the trigger voltage Vd, a signal S2 is generated.

The processing module 430 is coupled between the detection module 410 and a gate of the transistor T1, and is adapted to conduct a logic processing to the signal S1, so as to generate an enable signal E1 to the gate of the transistor T1, to conduct the transistor T1. The processing module 440 is coupled between the detection module 420 and a gate of the transistor T2, and is adapted to conduct a logic processing to the signal S2, so as to generate an enable signal E2 to the gate of the transistor T2, to conduct the transistor T2. In such a way, when any of the parasitic diodes D1 and D2 is triggered, the corresponding transistor is then conducted for conducting current, so as to avoid excessive current flowing into the current of the silicon controlled rectifier and causing latch-up.

The operating principle of the detection modules 410 and 420 can be learnt by respectively referring to the embodiments shown in FIGS. 2B and 3B, and the operating principle of the processing modules 430 and 440 can be learnt by respectively referring to the embodiments shown in FIGS. 2C and 3C, and thus are not to be iterated hereby. However, it should be noted that when the pad 450 is an input pad, the latch-up protection device 400 is applicable as an electrostatic discharge (ESD) protection device. As such, when an electrostatic current flows into the pad 450, it can instantly conduct (turn on) the transistors T1 and T2, and thus conduct the electrostatic current to a path of the system voltage VDD or the ground voltage VSS.

Further, when the pad 450 is an output pad, the latch-up protection device 400 is also applicable as an output buffer. Referring to FIGS. 2C and 3C, the signal SP3 of the processing module 430 and the signal SN3 of the processing module 440 are applicable to control signals of a pre-stage driver (not shown). Such a pre-stage driver is well known to those of ordinary skill in the art and is then not to be iterated hereby.

In summary, it is often unavoidable to configure additional parasitic silicon controlled rectifiers (SCR) during processing and layout of transistors. When excessive current flows into the circuit of the parasitic silicon controlled rectifier, there often causes a latch-up, which often causes malfunction of the circuit or even damages to the internal components. As such, the latch-up protection device according to the embodiment of the present invention employs a detection module to detect a terminal voltage between a first source/drain and a second source/drain of a transistor, in which when the terminal voltage is found greater than a trigger voltage, the transistor is conducted so as to conduct the current to a voltage path. In such a way, latch-up can be avoided and the circuit can be protected for normal operation.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A latch-up protection device, comprising:
a first transistor, comprising a first source/drain coupled to a pad, a body and a second source/drain coupled to a first voltage;
a detection module, for detecting a terminal voltage between the first source/drain and the second source/drain of the first transistor, and generating a first signal when the terminal voltage is greater than a trigger voltage; and
a processing module, coupled between the detection module and a gate of the first transistor, for conducting a logic processing to the first signal, and generating an enable signal to the gate of the first transistor to conduct the first transistor.

2. The latch-up protection device as claimed in claim 1, wherein the detection module comprises:
a second transistor, comprising a gate coupled to the first source/drain of the first transistor, and a first source/drain coupled to a second voltage;
a third transistor, comprising a gate coupled to the second source/drain of the first transistor, a first source/drain coupled to the first source/drain of the second transistor, and a second source/drain outputting the first signal;
a fourth transistor, comprising a gate and a first source/drain coupled to a second source/drain of the second transistor, and a second source/drain coupled to the first voltage; and
a fifth transistor, comprising a gate coupled to the gate of the fourth transistor, a first source/drain coupled to the second source/drain of the third transistor, and a second source/drain coupled to the second source/drain of the fourth transistor.

3. The latch-up protection device as claimed in claim 2, wherein the detection module further comprises:
a sixth transistor, comprising a gate coupled to the first voltage, a first source/drain coupled to the first source/drain of the second transistor, and a second source/drain coupled to the second voltage.

4. The latch-up protection device as claimed in claim 2, wherein the first voltage is a system voltage and the second voltage is a ground voltage.

5. The latch-up protection device as claimed in claim 1, wherein the detection module comprises:
a second transistor, comprising a gate coupled to the second source/drain of the first transistor, a first source/drain coupled to the first voltage;
a third transistor, comprising a gate coupled to the first source/drain of the first transistor, a first source/drain coupled to the first source/drain of the second transistor, and a second source/drain outputting the first signal;
a fourth transistor, comprising a gate and a first source/drain which are coupled to the second source/drain of the second transistor, and a second source/drain coupled to a second voltage; and
a fifth transistor, comprising a gate coupled to the gate of the fourth transistor, a first source/drain coupled to the second source/drain of the third transistor, and a second source/drain coupled to the second source/drain of the fourth transistor.

6. The latch-up protection device as claimed in claim 5, wherein the detection module further comprises:
a sixth transistor, comprising a gate coupled to the second voltage, a first source/drain coupled to the first source/drain of the second transistor, and a second source/drain coupled to the first voltage.

7. The latch-up protection device as claimed in claim 5, wherein the first voltage is a ground voltage and the second voltage is a system voltage.

8. The latch-up protection device as claimed in claim 1, wherein the processing module comprises:
a first inverter, receiving the first signal and generating a second signal;
a NAND gate, receiving the second signal and a third signal, and generating a fourth signal; and
a second inverter, receiving the fourth signal, and generating the enable signal.

9. The latch-up protection device as claimed in claim 8, wherein the third signal has a level of the first voltage.

10. The latch-up protection device as claimed in claim 8, wherein the third signal is a control signal generated by a pre-stage driver.

11. The latch-up protection device as claimed in claim 1, wherein the processing module comprises:
a first inverter, receiving the first signal;
a second inverter, comprising an input terminal coupled to an output terminal of the first inverter, and generating a second signal;
an NOR gate, receiving the second signal and a third signal, and generating a fourth signal; and
a third inverter, receiving the fourth signal, and generating the enable signal.

12. The latch-up protection device as claimed in claim 11, wherein the third signal has a level of the first voltage.

13. The latch-up protection device as claimed in claim 11, wherein the third signal is a control signal generated by a pre-stage driver.

14. The latch-up protection device as claimed in claim 1, wherein the pad is an input pad.

15. The latch-up protection device as claimed in claim 1, wherein the pad is an output pad.

16. A latch-up protection device, comprising:
a first transistor, comprising a first source/drain coupled to a pad, a body and a second source/drain coupled to a first voltage;
a second transistor, comprising a first source/drain coupled to the first source/drain of the first transistor, and a body and a second source/drain coupled to a second voltage;
a first detection module, for detecting a first terminal voltage between the first source/drain and the second source/drain of the first transistor, and generating a first signal when the first terminal voltage is greater than a trigger voltage;
a second detection module, for detecting a second terminal voltage between the first source/drain and the second source/drain of the second transistor, and generating a second signal when the second terminal voltage is greater than the trigger voltage;
a first processing module, coupled between the first detection module and a gate of the first transistor, for conducting a logic processing to the first signal, and generating a first enable signal to the gate of the first transistor to conduct the first transistor; and
a second processing module, coupled between the second detection module and a gate of the second transistor, for conducting a logic processing to the second signal, and generating a second enable signal to the gate of the second transistor to conduct the second transistor.

17. The latch-up protection device as claimed in claim 16, wherein the first detection module comprises:
a third transistor, comprising a gate coupled to the first source/drain of the first transistor, and a first source/drain coupled to the second voltage;
a fourth transistor, comprising a gate coupled to the second source/drain of the first transistor, a first source/drain coupled to the first source/drain of the third transistor, and a second source/drain outputting the first signal;
a fifth transistor, comprising a gate and a first source/drain coupled to a second source/drain of the third transistor, and a second source/drain coupled to the first voltage; and
a sixth transistor, comprising a gate coupled to the gate of the fifth transistor, a first source/drain coupled to the second source/drain of the fourth transistor, and a second source/drain coupled to the second source/drain of the fifth transistor.

18. The latch-up protection device as claimed in claim 17, wherein the first detection module further comprises:
a seventh transistor, comprising a gate coupled to the first voltage, a first source/drain coupled to the first source/drain of the third transistor, and a second source/drain coupled to the second voltage.

19. The latch-up protection device as claimed in claim 16, wherein the second detection module comprises:
a third transistor, comprising a gate coupled to the second source/drain of the second transistor, and a first source/drain coupled to the second voltage;
a fourth transistor, comprising a gate coupled to the first source/drain of the second transistor, a first source/drain coupled to the first source/drain of the third transistor, and a second source/drain outputting the second signal;
a fifth transistor, comprising a gate and a first source/drain coupled to a second source/drain of the third transistor, and a second source/drain coupled to the first voltage; and
a sixth transistor, comprising a gate coupled to the gate of the fifth transistor, a first source/drain coupled to the second source/drain of the fourth transistor, and a second source/drain coupled to the second source/drain of the fifth transistor.

20. The latch-up protection device as claimed in claim 19, wherein the second detection module further comprises:
a seventh transistor, comprising a gate coupled to the first voltage, a first source/drain coupled to the first source/drain of the third transistor, and a second source/drain coupled to the second voltage.

21. The latch-up protection device as claimed in claim 16, wherein the first processing module comprises:
a first inverter, receiving the first signal and generating a third signal;
a NAND gate, receiving the third signal and a fourth signal, and generating a fifth signal; and
a second inverter, receiving the fifth signal, and generating the first enable signal.

22. The latch-up protection device as claimed in claim 21, wherein the fourth signal has a level of the first voltage.

23. The latch-up protection device according to claim 21, wherein the fourth signal is a control signal generated by a pre-stage driver.

24. The latch-up protection device as claimed in claim 16, wherein the second processing module comprises:
a first inverter, receiving the second signal;
a second inverter, comprising an input terminal coupled to an output terminal of the first inverter, and generating a third signal;
an NOR gate, receiving the third signal and the fourth signal, and generating a fifth signal; and
a third inverter, receiving the fifth signal, and generating the second enable signal.

25. The latch-up protection device as claimed in claim 24, wherein the fourth signal has a level of the second voltage.

26. The latch-up protection device as claimed in claim 24, wherein the third signal is a control signal generated by a pre-stage driver.

27. The latch-up protection device as claimed in claim 16, wherein the first voltage is a system voltage and the second voltage is a ground voltage.

28. The latch-up protection device as claimed in claim 16, wherein the pad is an input pad.

29. The latch-up protection device as claimed in claim 16, wherein the pad is an output pad.
